(19) United States
(12) Patent Application Publication
(10) Pub. No.: US 2016/0199750 A1
(43) Pub. Date: Jul. 14, 2016

(54) METHOD FOR MANUFACTURING WOODEN BUILDING BLOCKS

(71) Applicant: NEW TECH SHINSEI CO., LTD., Yonezawa-shi (JP)

(72) Inventor: Shinji YAMAGISHI, Yonezawa-shi (JP)

(21) Appl. No.: 14/901,986

(22) PCT Filed: Jul. 5, 2013
(86) PCT No.: PCT/JP2013/068485

§ 371 Date: Dec. 29, 2015

(51) Int. Cl. A63H 33/08; B27M 3/00; B27K 1/00

(52) U.S. Cl. CPC A63H 33/086; B27K 1/00; B27M 3/00

(57) ABSTRACT

Wooden building blocks that can be mutually coupled or decoupled appropriately are manufactured. A method for manufacturing a block 1 includes: a step (S3) of decreasing the moisture content of lumber 51a by drying the lumber 51a; a step (S5, S7, and S9) of increasing the moisture content of the dried lumber 51a and making the moisture content uniform; and a step (S10) of forming the block 1 by subjecting the lumber 51a with the uniform moisture content to shaving machining.

### TECHNICAL FIELD

The present invention relates to a method for manufacturing wooden building blocks.

### BACKGROUND ART

Patent Document 1 discloses toy building blocks (structural elements).

A plurality of building blocks of this type can function as a toy when coupled to one another and assembled in a desired shape.

An exemplary building block includes: a box-shaped block main body that is open at its lower surface; a plurality of projections that protrudes upward from the upper surface of the block main body; and an engaging section that is positioned inside the block main body and accommodates and engages with projections of another wooden block when both building blocks are coupled.

Some known building blocks are made of resin, wood, or sawdust solidified with resin. Non-Patent Document 1 discloses wooden building blocks.

### REFERENCE DOCUMENT LIST

### Patent Document

Patent Document 1: Japanese Patent No. 4422344

### Non-Patent Document

Non-Patent Document 1: New Tech Shinsei Co., Ltd., Mokulock Division, “Mokulock Paper Vol. 2,” pp. 1-8, online, January 2013, New Tech Shinsei Co., Ltd., Mokulock Division, retrieved Jun. 21, 2013, Internet, URL: http://mokulock.com/catalog2.pdf

### SUMMARY OF THE INVENTION

### Problems to be Solved by the Invention

If building blocks as described above are made by shaving a piece of lumber instead of using resin or the like, a user can feel the texture and smell of wood when handling the building blocks.

However, if the moisture contents of the lumber are nonuniform before the shaving process, unequal shrinkage and swelling of the building blocks to be used (coupled), which have been made by shaving the lumber, may take place. This may make it difficult to couple the building blocks, or even when it is possible to couple the building blocks, these building blocks may be firmly engaged with each other and unable to be decoupled easily.

The present invention has been made in light of this situation and seeks to manufacture wooden building blocks that can be mutually coupled or decoupled appropriately.

### Means for Solving the Problems

According to an aspect of the present invention, a method for manufacturing wooden building blocks includes the steps of: increasing a moisture content of lumber that has been dried and making the moisture content uniform; and forming a wooden building block by subjecting the lumber with the uniform moisture content to shaving machining.

According to another aspect of the present invention, a method for manufacturing wooden building blocks includes the steps of: increasing a moisture content of lumber that has been dried and making the moisture content uniform by leaving the lumber under atmospheric conditions of a relative humidity controlled to be a first relative humidity; and forming a wooden building block by subjecting the lumber with the uniform moisture content to shaving machining under the atmospheric conditions of a relative humidity controlled to be the first relative humidity. The wooden building block includes: a box-shaped block main body that is open at a lower surface; a plurality of projections protruding upward from an upper surface of the block main body; and an engaging section positioned inside the block main body, the engaging section accommodating and engaging with projections of another wooden building block when both wooden building blocks are coupled. The block main body, the projections, and the engaging section are formed by the shaving machining.

According to another aspect of the present invention, a method for manufacturing wooden building blocks includes the steps of: decreasing a moisture content of lumber by drying the lumber under atmospheric conditions of a relative humidity controlled to be a second relative humidity; increasing the moisture content of the lumber that has been dried and making the moisture content uniform by leaving the lumber under atmospheric conditions of a relative humidity controlled to be a first relative humidity, the first relative humidity being higher than the second relative humidity; and forming a wooden building block by subjecting the lumber with the uniform moisture content to shaving machining under the atmospheric conditions of a relative humidity controlled to be the first relative humidity. The wooden building block includes: a box-shaped block main body that is open at a lower surface; a plurality of projections protruding upward from an upper surface of the block main body; and an engaging section positioned inside the block main body, the engaging section accommodating and engaging with projections of another wooden building block when both wooden building blocks are coupled. The block main body, the projections, and the engaging section are formed by the shaving machining.

As used herein, “moisture content of lumber” refers to the proportion by weight of water contained in lumber. As used herein, “make the moisture content of lumber uniform” implies equalizing moisture content in each corresponding portion of lumber (i.e., reducing differences in moisture content at corresponding portions of lumber). As used herein, “make the moisture content of lumber uniform” may further imply leaving lumber with decreased differences in moisture content over a preset period (e.g., for several months), thereby aging the lumber with this moisture content (i.e., stabilizing the moisture content).

### Effects of the Invention

According to the present invention, the moisture content of dried lumber is increased and made uniform. More specifically, lumber is dried so that its moisture content is decreased, and then the moisture content is increased and made uniform. In this way, an entire piece of lumber assumes a state of being able to absorb moisture before the moisture content of the entire piece of lumber is increased and made uniform. Differences in moisture content of the lumber thereby can be decreased. Consequently, it is possible to reduce unequal shrinkage and swelling among wooden building blocks, allowing these wooden building blocks to be mutually coupled or decoupled appropriately.

### BRIEF DESCRIPTION OF THE DRAWINGS

FIG. 1 is a perspective view of a wooden building block according to an embodiment of the present invention.

FIG. 2 is a top view of the wooden building block.

FIG. 3 is a cross-sectional view taken along with the line I-I in FIG. 2.

FIG. 4 is a bottom view of the wooden building block.

FIG. 5 is a view illustrating a coupling state of wooden building blocks.

FIG. 6 is a view illustrating a coupling state of wooden building blocks.

FIG. 7 is a view illustrating a log of a broad-leaved tree.

FIG. 8 is a view illustrating a piece of square lumber obtained by sawing the log.

FIG. 9 is a view of the relationships among moisture content, directions of shrinkage, and shrinkage of a piece of square lumber (lumber).

FIG. 10 is a flowchart of a method for manufacturing a wooden building block.

FIG. 11 is a flowchart of the method for manufacturing a wooden building block.

FIG. 12 is a view illustrating a general configuration of an exemplary cutting apparatus.

### MODE FOR CARRYING OUT THE INVENTION

An embodiment of the present invention will be described below with reference to the accompanying drawings.

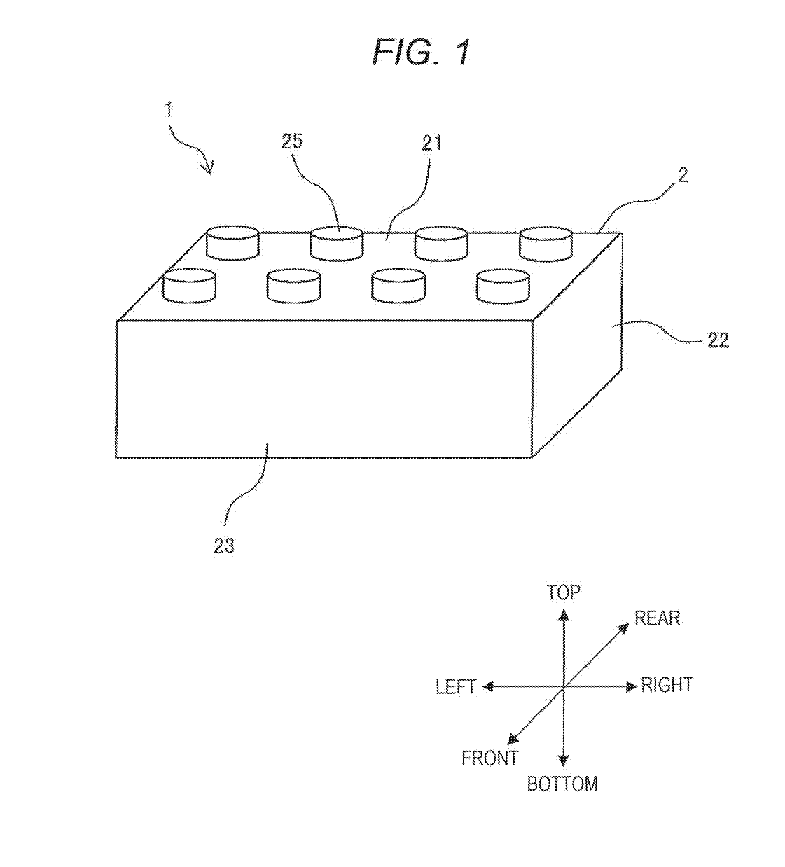

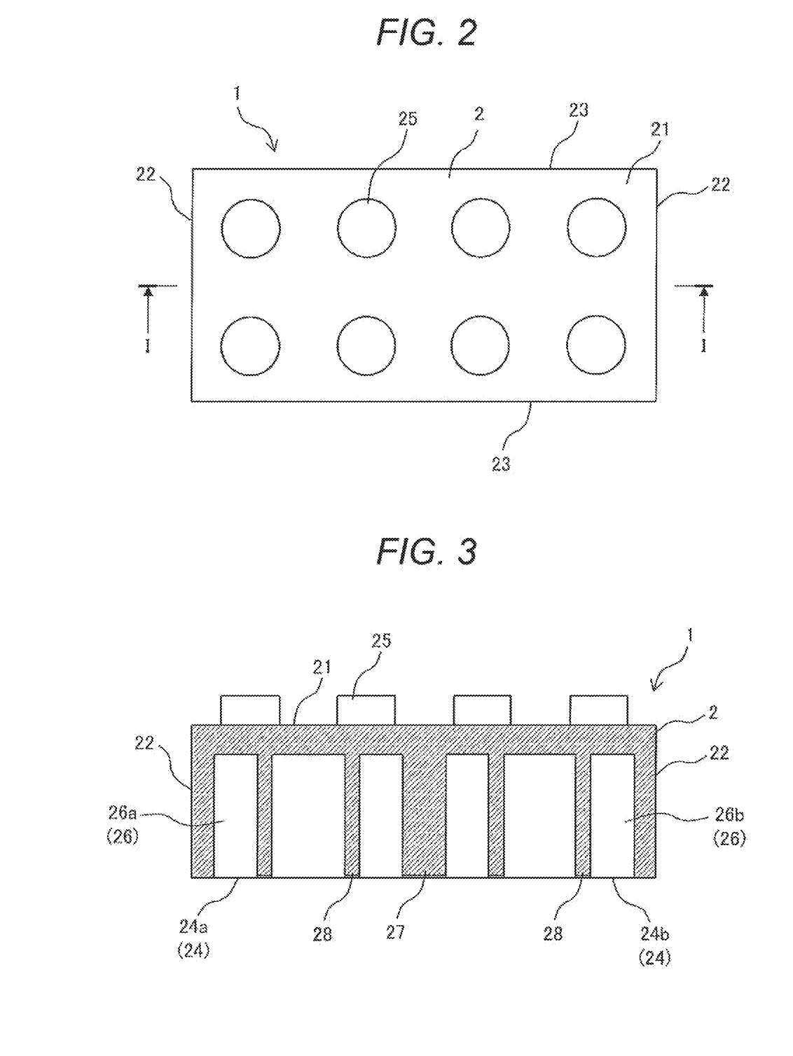

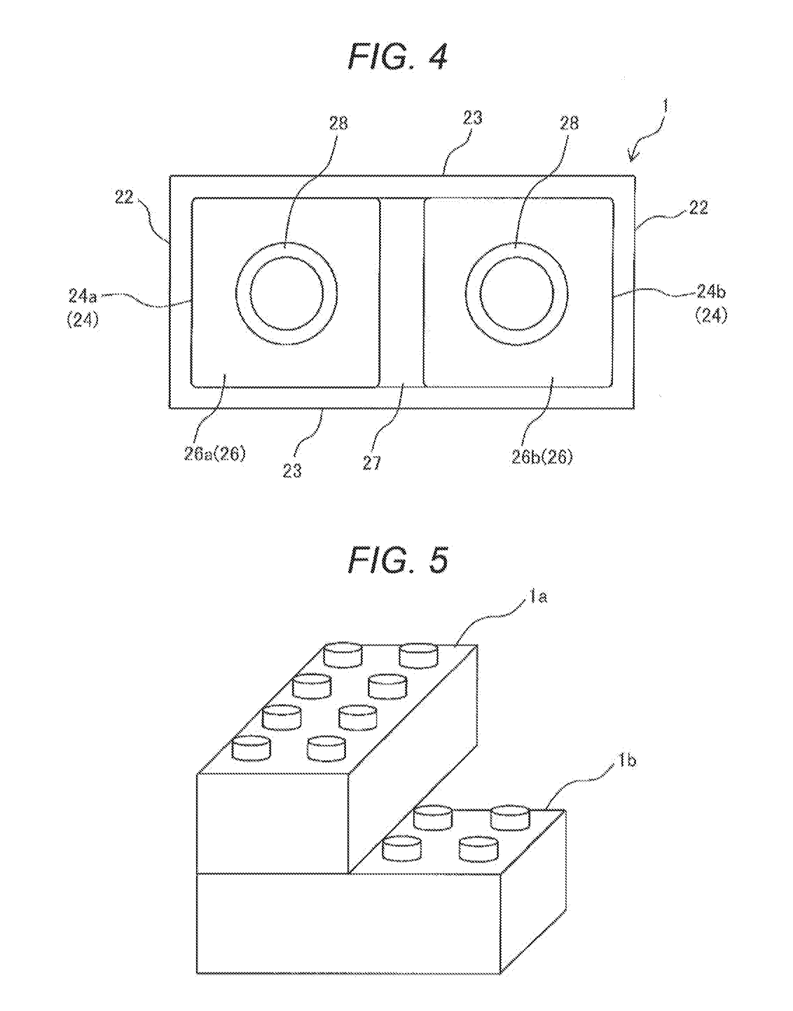

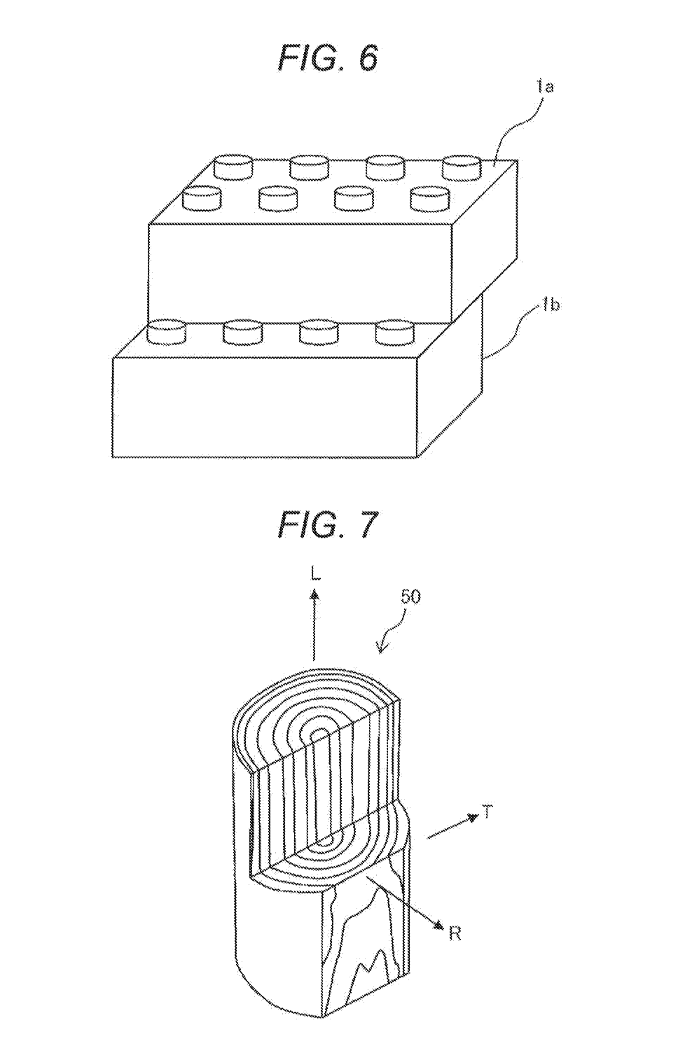

FIG. 1 is a perspective view of a wooden building block according to an embodiment of the present invention. FIG. 2 is a top view of the wooden building block. FIG. 3 is a cross-sectional view taken along with the line I-I in FIG. 2. FIG. 4 is a bottom view of the wooden building block. FIG. 5 is a view illustrating a state in which two wooden building blocks are coupled with their longitudinal directions orthogonal to each other when projected in a plan view. FIG. 6 is a view illustrating a state in which two wooden building blocks are coupled with their longitudinal directions parallel to each other when projected in a plan view. In the following description, the top, bottom, front, rear, right, and left of a wooden building block are defined as illustrated in FIG. 1, for the sake of convenience.

A wooden building block 1 (hereinafter, referred to as just a “block 1”) illustrated in FIGS. 1 to 4 is formed by shaving a piece of lumber. The lumber for the block 1 is preferably obtained from a broad-leaved tree, such as cherry, magnolia, painted maple, hornbeam, or birch. The air-dried specific gravity of the lumber may fall within the range from approximately 0.4 to 0.8 both inclusive. It should be noted that configurations of blocks 1a and 1b illustrated in FIGS. 5 and 6 are the same as that of the block 1 illustrated in FIGS. 1 to 4.

As illustrated in FIGS. 1 to 4, the block 1 includes a block main body 2 having a cuboid shape. An exemplary size of the block main body 2 is 32 mm (width)×16 mm (depth)×10 mm (height).

The block main body 2 includes: an upper wall 21 having a rectangular shape; a right and left pair of side walls 22 having a rectangular shape; a front and rear pair of side walls 23 having a rectangular shape; and an opening (lower-surface opening) 24 having a rectangular shape. The outer edge of the upper wall 21 continues to both the upper edges of the right and left pair of the side walls 22 and the front and rear pair of side walls 23. The opening 24 is surrounded by the lower edges of the right and left pair of side walls 22 and the front and rear pair of side walls 23. In short, the block main body 2 has a box shape and is open at its lower surface. In this case, the outer surfaces of the side walls 22 correspond to “short-side surfaces” in the present invention, and the outer surfaces of the side walls 23 correspond to “long-side surfaces” in the present invention. The side walls 22 and the side walls 23 have the same thickness.

Formed on the outer surface of the upper wall 21 of the block main body 2 (i.e., on the upper surface of the block main body 2) is a plurality of projections 25. As for an arrangement of the projections 25 illustrated in FIGS. 1 to 4, eight projections 25 are arranged in a matrix fashion when projected in a plan view (two rows in the longitudinal direction and four columns in the direction perpendicular thereto are arranged in the figures). In addition, the projections 25 protrude upward from the upper surface of the block main body 2. The distance between adjacent projections 25 is set to about twice the thickness of the side walls 22 and 23. The number of projections 25 formed on the upper surface of the block main body 2 is not limited to eight.

The block main body 2 has an internal space 26 that is formed and partitioned by the upper wall 21 and the side walls 22 and 23 and communicates with the outside via the opening 24. This internal space 26 is equally divided into a left internal space 26a and a right internal space 26b by a rib 27 taking the shape of a rectangular plate. In other words, the left internal space 26a and the right internal space 26b are separated from each other by the rib 27.

The front and rear ends of the rib 27 continue to the respective side walls 23. The upper end of the rib 27 continues to the upper wall 23. The lower end surface of the rib 27 is positioned slightly higher than the lower end surfaces of the side walls 22 and 23.

The thickness of the rib 27 is about twice as great as that of the side walls 22 and 23. That is, the rib 27 has a greater thickness than the side walls 22 and 23.

The rib 27 is positioned at the center of the opening 24 when viewed from the bottom, separating the opening 24 into the two opening portions 24a and 24b.

Positioned in each of the internal spaces 26a and 26b is a cylindrical hollow unit (cylindrical hollow projection) 28 that extends vertically. Each cylindrical hollow unit 28 has an upper end that continues to the upper wall 21 and a lower end surface positioned slightly higher than the lower end surfaces of the side walls 22 and 23. That is, the cylindrical hollow units 28 are positioned within the respective internal spaces 26a and 26b and protrude downward from the inner surface of the upper wall 21. The cylindrical hollow units 28 are positioned at the centers of the respective internal spaces 26a and 26b when projected in a plan view. Thus, the cylindrical hollow units 28 are positioned within the respective opening portions 24a and 24b when viewed from the bottom.

Instead of the cylindrical hollow units 28, a cylindrical solid unit (cylindrical solid projection) (not shown) may be positioned within each of the internal spaces 26a and 26b. However, the cylindrical hollow units 28 are preferably employed, because the cylindrical hollow units 28 can provide a softer feeling than the cylindrical solid units when the blocks 1a and 1b are coupled.

When the blocks 1a and 1b are coupled as illustrated in FIG. 5 or 6, projections 25 of the block 1b are accommodated in an internal space 26 of the block 1a and engage with an engaging section constituted by side walls 22 and 23 and a cylindrical hollow unit 28 or engage with an engaging section constituted by a side wall 23, a rib 27, and cylindrical hollow units 28. In this case, the side walls 22 and 23, the rib 27, and the cylindrical hollow units 28 of the block main body 2 function as an “engaging section that accommodates and engages with projections of another wooden building block” in the present invention.

The outer surface of the upper wall 21 of the block main body 2 (the upper surface of the block main body 2) is an end grain surface.

One of the outer surfaces of the side walls 22 and 23 (one of the short-side and long-side surfaces) of the block main body 2 is an edge grain surface (a straight grain surface), whereas the other thereof is a cross grain surface. More specifically, if the short-side surface of the block main body 2 is an edge grain surface, the long-side surface of the block main body 2 is a cross grain surface. If the short-side surface of the block main body 2 is a cross grain surface, the long-side surface of the block main body 2 is an edge grain surface.

A description will be given of the relationship between the moisture content of the lumber that forms blocks 1 and shrinkage and swelling of the lumber, with reference to FIGS. 7 to 9.

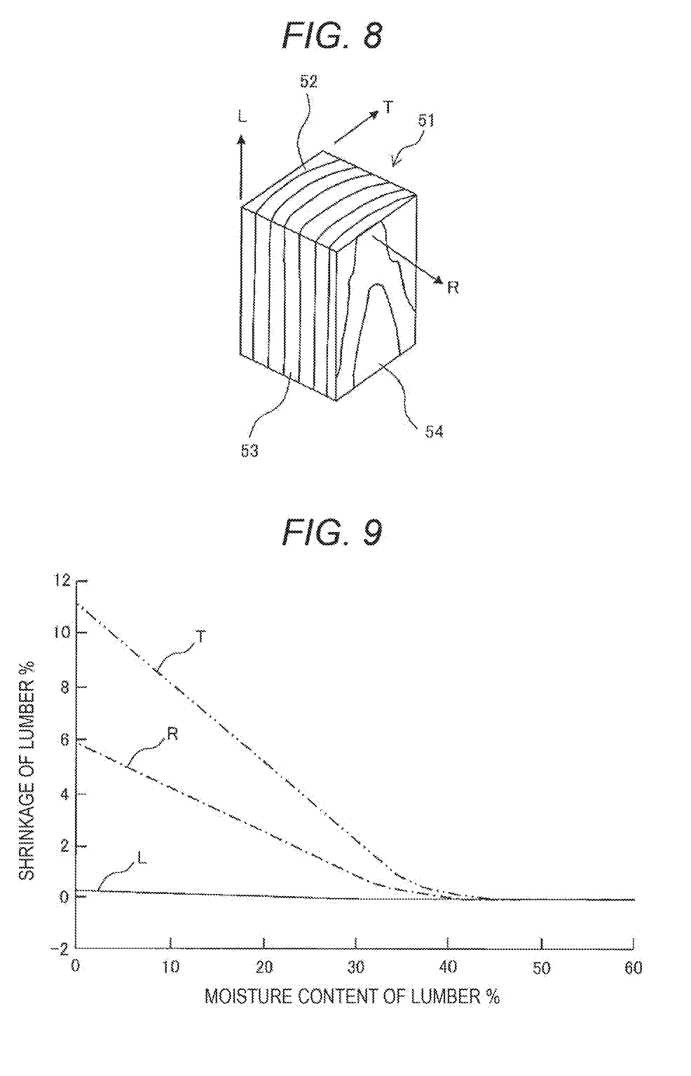

FIG. 7 is a view illustrating a log 50 of a broad-leaved tree, which is to be used to manufacture the block 1. FIG. 8 is a view illustrating a piece of square lumber 51 obtained by sawing the log 50. FIG. 9 is a view showing the relationship among a moisture content, directions of shrinkage, and shrinkage of a piece of square lumber 51 (lumber).

In FIG. 7, a length direction (fiber direction) L, a radius direction R of the annual ring, and a tangential direction T of the annual ring of the log 50 are indicated. In FIG. 8, the relationship between an end grain surface 52, an edge grain surface 53, and a cross grain surface 54 of the square lumber 51, and the length direction L, the radius direction R, and the tangential direction T as described above is indicated. With regard to the square lumber 51, the length direction L is referred to as an “end grain direction L”. The radius direction R is referred to as an “edge grain direction R”. The tangential direction T is referred to as a “cross grain direction T”.

Referring to FIG. 9, as the moisture content of the square lumber 51 decreases, the shrinkages of the square lumber 51 in the end grain direction L, the edge grain direction R, and the cross grain direction T increase. In this case, the shrinkage of the square lumber 51 is defined as the ratio of the lengths of the square lumber 51, which have shrunk in the individual directions L, R, and T, relative to the respective lengths of the square lumber 51 in the directions L, R, and T at the moisture content of 60%.

When the moisture content of the square lumber 51 in the range of more than 0% to 30% inclusive is decreased by 1%, the square lumber 51 shrinks in the end grain direction L by approximately 0.01%, in the edge grain direction R by approximately 0.15%, and in the cross grain direction T by approximately 0.25%. Therefore, when the moisture content of the square lumber 51 changes in the range of more than 0% to 30% inclusive, the shrinkage and swelling in the cross grain direction T becomes about 1.6 times as great as that in the edge grain direction R. In addition, the shrinkage and swelling in the edge grain direction R becomes about 15 times as great as that in the end grain direction L. The shrinkage and swelling in the cross grain direction T becomes about 25 times as great as that in the end grain direction L.

In the block 1 that can assume various coupling aspects as illustrated in FIG. 5 or 6, one of the short-side and long-side surfaces of the block main body 2 is formed in an edge grain fashion, whereas the other thereof is formed in a cross grain fashion. This can decrease the shrinkage and swelling in the right and left direction to about 0.6 to 1.6 times that in the forward and backward direction. Consequently, blocks 1 can be mutually coupled or decoupled in use appropriately. Furthermore, by forming the upper surface of the block main body 2 in an end grain fashion, the creation of burrs on the projections 25 can be reduced.

Suppose multiple pieces of square lumber 51 are bought from a lumber company or other associated company, and many blocks 1 are manufactured using these pieces of square lumber 51. If the pieces of square lumber 51 have greatly different moisture contents, unequal shrinkage and swelling of the blocks 1 to be used (coupled) may take place. Likewise, if each piece of square lumber 51 has a nonuniform moisture content distribution, unequal shrinkage and swelling of the blocks 1 to be used may take place.

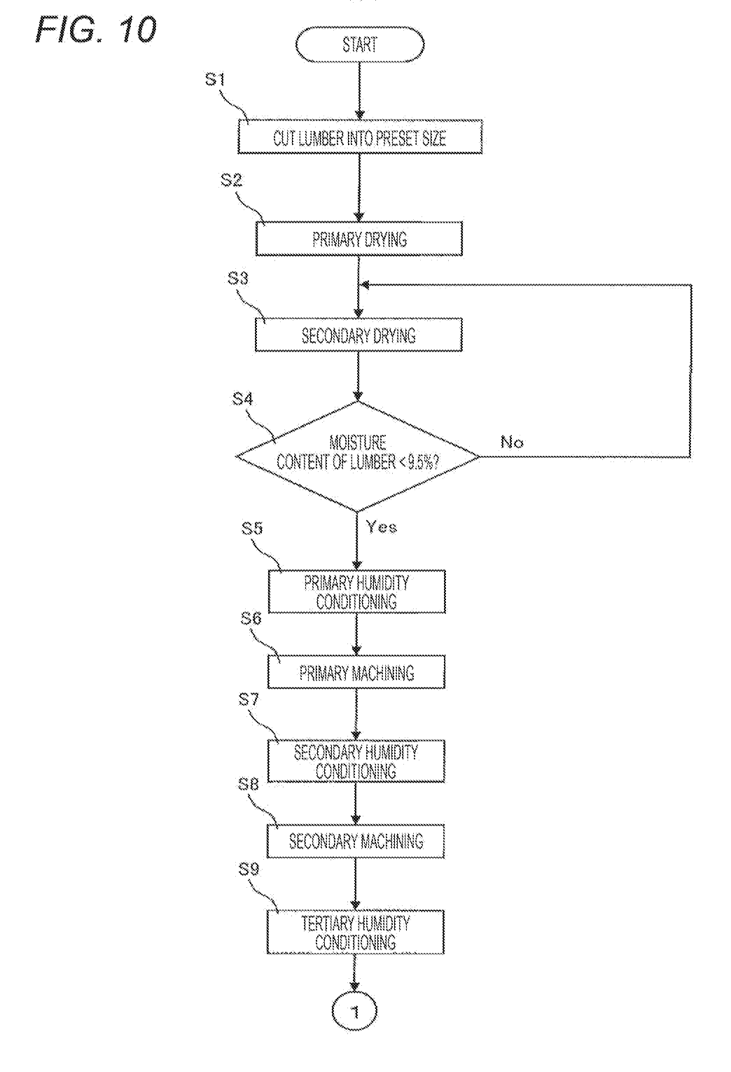

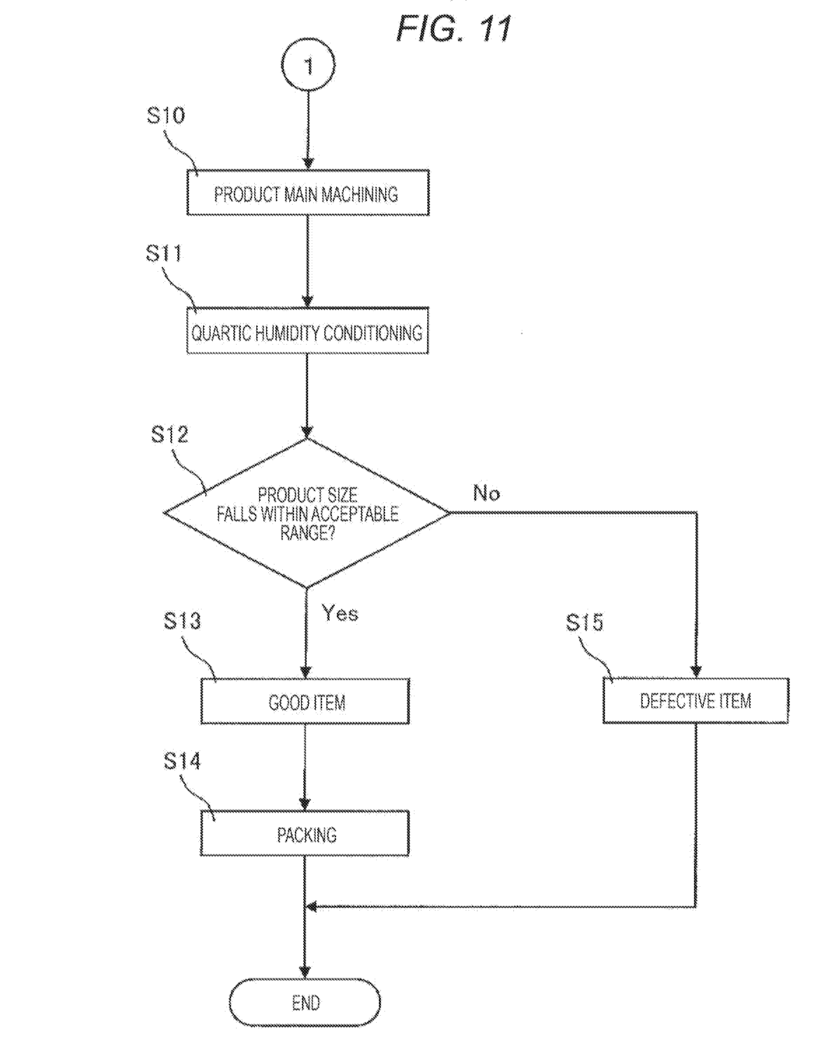

For this reason, the embodiment employs a method for manufacturing the blocks 1 illustrated in FIGS. 10 and 11, reducing unequal shrinkage and swelling among the blocks 1 in use and thus further improving coupling and decoupling property of the blocks 1.

FIGS. 10 and 11 are flowcharts of a method for manufacturing the blocks 1. It should be noted that Steps S1 to S14, described below, are performed under room temperature atmospheric conditions (in the range from 20° C. to 25° C. inclusive).

At Step S1, first, a long piece of lumber (square lumber 51) is cut into a preset size (e.g., 400 mm long), forming a plurality of lumber pieces (multiple pieces of lumber 51a). Then, the procedure proceeds to Step S2.

Step S2 is a primary drying step. At the primary drying step, the pieces of lumber 51a are dried under atmospheric conditions of a relative humidity controlled in the range from 45% RH to 55% RH both inclusive. At the primary drying step, the pieces of lumber 51a are subjected to aging dehumidification over a period of about one week to one month. Since the pieces of lumber 51a have been shortened at Step S1, the aging dehumidification can be applied appropriately to the interior of the pieces of lumber 51a. After that, the procedure proceeds to Step S3.

Step S3 is a secondary drying step. At the secondary drying step, the pieces of lumber 51a are dried under atmospheric conditions of a relative humidity controlled to be in the range from 20% RH to 35% RH both inclusive. At the secondary drying step, the pieces of lumber 51a are subjected to dehumidification over a period of about one to six months. In this case, if the pieces of lumber 51a are dried under atmospheric conditions of a relative humidity controlled to less than 20% RH at the secondary drying step, the pieces of lumber 51a may crack due to an excessively high drying rate. If the pieces of lumber 51a are dried under atmospheric conditions of a relative humidity controlled to more than 35% RH at the secondary drying step, it may need a longer time to dry the pieces of lumber 51a due to an excessively low drying rate. For these reasons, the pieces of lumber 51a are dried under the atmospheric conditions of a relative humidity controlled in the range from 20% RH to 35% RH both inclusive at the secondary drying step in the embodiment. This can both reduce the creation of cracks in the lumber 51a and dry the lumber 51a efficiently.

Here, the reason the drying step for the pieces of lumber 51a is divided into the primary drying step (Step S2) and the secondary drying step (Step S3) will be described.

Prior to Step S2, some pieces of lumber 51a may have a moisture content of approximately 12% to 40%. If the pieces of lumber 51a that have such greatly different moisture contents are dried at the same time under the atmospheric conditions of a relative humidity controlled in the range from 20% RH to 35% RH both inclusive as in Step S3, the pieces of lumber 51a may crack. To prevent this, the pieces of lumber 51a that have high moisture contents are subjected to aging dehumidification at Step S2 in the embodiment. The moisture contents of the pieces of lumber 51a are thereby decreased to 20% or below. Thus, the differences in moisture contents among the pieces of lumber 51a are reduced. Subsequently, the pieces of lumber 51a are dried under the atmospheric conditions of a relative humidity controlled in the range from 20% RH to 35% RH both inclusive at Step S3. The moisture contents of the pieces of lumber 51a are thereby decreased to less than 9.5%. In this way, by drying the pieces of lumber 51a under the atmospheric conditions of a relative humidity controlled in the range from 20% RH to 35% RH both inclusive, the moisture contents of the pieces of lumber 51a can be decreased to less than 9.5%, while the creation of cracks in the pieces of lumber 51a are reduced even when the pieces of lumber 51a have greatly different moisture contents. Herein, the relative humidity of the atmospheric conditions at Step S3 corresponds to a “second relative humidity” in the present invention.

At Step S4, it is determined one by one whether the moisture contents of the pieces of lumber 51a that have been subjected to the secondary drying step (Step S3) are less than 9.5%. In this case, for example the moisture content of each piece of lumber 51a at the center may be measured with a high-frequency type moisture content meter, and the determination may be made on the basis of a measurement obtained. The lumber 51a tends to exhibit an increasing moisture content from one end toward the center. Therefore, if a measurement of the moisture content of lumber 51a at the center is less than 9.5%, the moisture content of the lumber 51a at both ends can also be estimated to be less than 9.5%.

At Step S4, when it is determined that the moisture contents of the pieces of lumber 51a are not less than 9.5% (i.e., are equal to or more than 9.5%), the procedure returns to Step S3. When it is determined that the moisture contents of the pieces of lumber 51a are less than 9.5%, the procedure proceeds to Step S5.

Step S5 is a primary humidity conditioning step. In the primary humidity conditioning step, the pieces of lumber 51a are left for about at least one month (e.g., several months) preferably under atmospheric conditions of a relative humidity controlled in the range from 40% RH to 60% RH both inclusive, more preferably under atmospheric conditions of a relative humidity controlled in the range from 45% RH to 55% RH both inclusive (i.e., under atmospheric conditions of a relative humidity controlled to approximately 50% RH). At the primary humidity conditioning step, the moisture contents of the pieces of lumber 51a are increased to the range from 9.5% to 10.5% both inclusive, to make the moisture contents uniform. Since the moisture contents of each piece of lumber 51a at not only the center but also both ends are increased to the range from 9.5% to 10.5% both inclusive at this primary humidity conditioning step, the moisture contents within the piece of lumber 51a can be uniform. In making the moisture contents of the pieces of lumber 51a uniform, the pieces of lumber 51a are left over a preset period (e.g., about two weeks) under the above atmospheric conditions for the primary humidity conditioning step, whereby the moisture contents of the pieces of lumber 51a are made uniform in the range from 9.5% to 10.5% both inclusive (first step). Following this, the pieces of lumber 51a are left over a preset period (e.g., a period of about one week to several months) under the above atmospheric conditions for the primary humidity conditioning step, whereby the moisture contents of the pieces of lumber 51a are aged with the moisture content in the range from 9.5% to 10.5% both inclusive (second step (stabilizing step)). By aging the pieces of lumber 51a in this manner, even if a dry condition surrounding the pieces of lumber 51a changes, the moisture contents of the pieces of lumber 51a can be prevented from varying in accordance with the change. After the primary humidity conditioning step has been completed, the process proceeds to Step S6.

Step S6 is a primary machining step. At the primary machining step, the surface layers of the pieces of lumber 51a are machined. After the machining, the process proceeds to Step S7. As a result of the machining at Step S6, the moisture contents of the pieces of lumber 51a slightly decrease.

Step S7 is a secondary humidity conditioning step. At the secondary humidity conditioning step, the pieces of lumber 51a are left for at least one day preferably under atmospheric conditions of a relative humidity controlled in the range from 40% RH to 60% RH both inclusive, more preferably under atmospheric conditions of a relative humidity controlled to be in the range from 45% RH to 55% RH both inclusive (i.e., under atmospheric conditions of a relative humidity controlled to be approximately 50% RH). The moisture contents of the pieces of lumber 51a are increased to the range from 9.5% to 10.5% both inclusive, to make the moisture contents uniform at the secondary humidity conditioning step. After that, the procedure proceeds to Step S8.

Step S8 is a secondary machining step. At the secondary machining step, the pieces of lumber 51a are machined into a size suitable for product main machining at Step S10 that will be described later. After the machining, the process proceeds to Step S9. As a result of the machining at Step S8, the moisture contents of the pieces of lumber 51a slightly decrease.

Step S9 is a tertiary humidity conditioning step. At the tertiary humidity conditioning step, the pieces of lumber 51a are left for at least one day preferably under atmospheric conditions of a relative humidity controlled to be in the range from 40% RH to 60% RH both inclusive, more preferably under atmospheric conditions of a relative humidity controlled to be in the range from 45% RH to 55% RH both inclusive (i.e., under atmospheric conditions of a relative humidity controlled to be approximately 50% RH). Through the tertiary humidity conditioning step, the moisture contents of the pieces of lumber 51a are increased to the range from 9.5% to 10.5% both inclusive, to make the moisture contents uniform. After that, the procedure proceeds to Step S10.

Step S10 is a product main machining step. At the product main machining step, the pieces of lumber 51a are machined to form products (i.e., blocks 1) preferably under atmospheric conditions of a relative humidity controlled to be in the range from 40% RH to 60% RH both inclusive, more preferably under atmospheric conditions of a relative humidity controlled to be in the range from 45% RH to 55% RH both inclusive (i.e., under atmospheric conditions of a relative humidity controlled to be approximately 50% RH). Through this step, the pieces of lumber 51a are subjected to shaving machining to form the blocks 1.

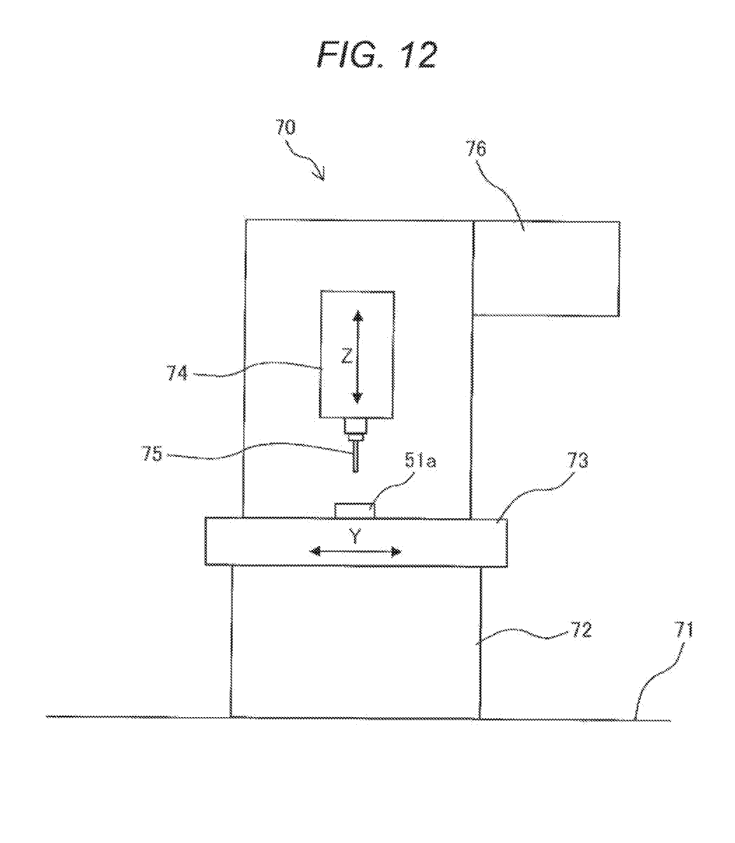

FIG. 12 is a view illustrating a general configuration of an exemplary cutting apparatus that can be used at Step S10.

A cutting apparatus 70 includes a base 72 placed on a floor surface 71, a table 73, a head 74, a cutting tool 75, and a control panel 76.

The table 73 is mounted on the base 72 so as to be movable freely in X directions (depth directions) and Y directions (width directions). A piece of lumber 51a is fixed to the table 73 via a jig (not shown).

The head 74 is disposed above the table 73 and configured to move forward and backward in Z directions (height directions).

The cutting tool 75 is attached to the lower end of the head 74 so as to be rotatable freely around the Z axis. The cutting tool 75 is an end mill, for example.

The control panel 76 includes an input section and an output section (both not shown) and executes various controls, including an operation control of the cutting apparatus 70.

In the shaving machining performed by the cutting apparatus 70, an operation of the blade edge of the cutting tool 75 is defined with a coordinate value via the input section of the control panel 76. The control panel 76 operates the table 73 and the cutting tool 75 by operating a servomotor (not shown) and the like on the basis of the defined information. The lumber 51a on the table 73 is thereby cut by the cutting tool 75. The cutting state can be monitored by monitoring the output section (e.g., monitor) of the control panel 76. In this way, the numerical control of the shaving machining can be achieved by the cutting apparatus 70.

In the embodiment, the table 73 is movable freely in the X and Y directions; however, the table 73 may be fixed to the base 72 and the head 74 may be movable freely in the X and Y directions.

At Step S10, or at the product main machining step, first, the lumber 51a is placed in the cutting apparatus 70 via the jig. Then, the cutting apparatus 70 subjects the lumber 51a to cutting machining by which the upper surfaces and the projections 25 of a plurality of blocks 1 is formed (cutting step α). In short, the projections 25 of the blocks 1 are created in the cutting step α. Then, the lumber 51a is turned upside down and placed again in the cutting apparatus 70 via the jig. Following this, the cutting apparatus 70 subjects the lumber 51a to cutting machining by which the opening 24, the internal spaces 26a and 26b, the rib 27, and the cylindrical hollow units 28 of a single block 1 are formed (cutting step β). In short, the engaging section of a block 1 is created in the cutting step β. Then, the cutting apparatus 70 performs cutting machining by which the single block 1 is separated (cutting step γ). After that, by repeating the cutting steps β and γ, a plurality of blocks 1 is manufactured. As a result of the cutting machining at Step S10, the moisture contents of the blocks 1 slightly decrease.

At Step S10, the cutting step α is performed before the cutting step β. A reason for this is as follows.

Assuming that after the cutting step β, the lumber 51a is turned upside down, placed again in the cutting apparatus 70 via the jig and subjected to the cutting step α at Step S10, since the thickness of the side portions of the lumber 51a have been made thin through the cutting step β, the lumber 51a might be deformed and curved toward the upper surfaces of the blocks 1 when placed via the jig again. Furthermore, when the lumber 51a deformed and curved in this manner is subjected to the cutting step α, the upper surfaces of the blocks 1 cannot be easily grinded flatly. This makes it difficult to allow the sizes of the blocks 1 to fall within an acceptable range.

In the embodiment, after the cutting step α, the lumber 51a is turned upside down, placed again in the cutting apparatus 70 via the jig and subjected to the cutting step β at Step S10. This can prevent the lumber 51a from being deformed and curved, unlike the above, because the lumber 51a placed via the jig again has a sufficiently thick side portion.

At Step S10, an insertion allowance (press insertion allowance) of the blocks 1 is set depending on the type of the lumber 51a, and the above cutting machining is performed on the basis of this set value. If the lumber 51a is made of a soft wood, a long insertion allowance is set; if the lumber 51a is made of a hard wood, a short insertion allowance is set. This setting enables the blocks 1 to be mutually coupled or decoupled appropriately.

After the product main machining has been completed at Step S10, the procedure proceeds to Step S11.

Step S11 is a quartic humidity conditioning step. In the quartic humidity conditioning step, the blocks 1 are left for at least 12 hours preferably under atmospheric conditions of a relative humidity controlled to be in the range from 40% RH to 60% RH both inclusive, more preferably under atmospheric conditions of a relative humidity controlled to be in the range from 45% RH to 55% RH both inclusive (i.e., under atmospheric conditions of a relative humidity controlled to be approximately 50% RH). Through the quartic humidity conditioning step, the moisture contents of the blocks 1 are increased to the range from 9.5% to 10.5% both inclusive, to make the moisture contents uniform. After that, the procedure proceeds to Step S12.

At Step S12, it is determined whether the sizes of the blocks 1 (products) that have been subjected to the quartic humidity conditioning step (Step S11) fall within a predetermined acceptable range. More specifically, the sizes of the products are measured preferably under atmospheric conditions of a relative humidity controlled to be in the range from 40% RH to 60% RH both inclusive, more preferably under atmospheric conditions of a relative humidity controlled to be in the range from 45% RH to 55% RH both inclusive (i.e., under atmospheric conditions of a relative humidity controlled to be approximately 50% RH). Then, the determination is made on the basis of a measurement obtained. As used herein, “predetermined acceptable range” refers to the acceptable range of a product size for use in determining whether to ship blocks 1 as products.

At Step S12, if the sizes of the products fall within the predetermined acceptable range, the products are determined to be non-defective items (Step S13). Then, the procedure proceeds to Step S14, and the products will be packed. At Step S14, which is the packing step, the products are packed preferably under atmospheric conditions of a relative humidity controlled to be in the range from 40% RH to 60% RH both inclusive, more preferably under atmospheric conditions of a relative humidity controlled to be in the range from 45% RH to 55% RH both inclusive (i.e., under atmospheric conditions of a relative humidity controlled to be approximately 50% RH).

If the sizes of the products fall outside the predetermined acceptable range at Step S12, the products are determined to be defective items (Step S15). Products that have been determined to be defective items will be used as prototypes, small items, or samples or will be discarded.

Herein, the relative humidity of the atmospheric conditions at Steps S5, S7, S9, and S10 to S14 corresponds to a “first relative humidity” in the present invention. The “second relative humidity” described at Step S3 is lower than this “first relative humidity.”

The “first relative humidity” is set on the basis of the usage environment of the blocks 1.

For example, suppose the blocks 1 will be used in Japan. The relative humidity in Japan can vary in the range from approximately 20% RH to 80% RH depending on a season and the like. Therefore, the average of the relative humidity (i.e., a relative humidity of approximately 50% RH) may be set as the “first relative humidity.”

According to the embodiment, a method for manufacturing blocks 1 includes the steps of: increasing a moisture content of lumber 51a that has been dried and making the moisture content uniform (S5, S7, and S9); and forming a block 1 by subjecting the lumber 51a with the uniform moisture content to shaving machining (S10). In short, the lumber 51a is dried so that its moisture content decreases, and then the moisture content is increased and made uniform. The moisture content of the entire piece of lumber 51a thereby can be increased and made uniform after the entire piece of lumber 51a assumes a state of being able to absorb moisture. This can reduce differences in moisture content of the lumber 51a. Consequently, it is possible to reduce unequal shrinkage and swelling among the blocks 1, thus allowing the blocks 1 to be mutually coupled or decoupled appropriately.

According to the embodiment, at the step of increasing the moisture content of the lumber 51a and making the moisture content uniform (S5, S7, and S9), the lumber 51a is left under atmospheric conditions of a relative humidity controlled to be the “first relative humidity” so that the moisture content of the lumber 51a is increased and made uniform. This enables the moisture content of the lumber 51a to be increased and made uniform relatively easily.

According to the embodiment, at the step of forming the blocks 1 (S10), the lumber 51a is subjected to shaving machining under atmospheric conditions of a relative humidity controlled to be the “first relative humidity”, to form the blocks 1. This can reduce differences in moisture content of the lumber 51a during the shaving machining.

According to the embodiment, the “first relative humidity” is set on the basis of the usage environment of blocks 1. This can manufacture the blocks 1 under atmospheric conditions suitable for the usage environment of the blocks 1, making it possible to reduce unequal shrinkage and swelling among the blocks 1 in use. So, the blocks 1 can be mutually coupled or decoupled appropriately.

Furthermore, according to the embodiment, the “first relative humidity” is within a range from 40% RH to 60% RH both inclusive. This can reduce the shrinkage and swelling of the blocks 1 in use to a relatively small degree, even if the blocks 1 are used under a high or low humidity environment.

Furthermore, according to the embodiment, the method for manufacturing the blocks 1 further includes the step of decreasing the moisture content of the lumber 51a by drying the lumber 51a (S3), before the step of increasing the moisture content of the lumber 51a and making the moisture content uniform (S5). The step of decreasing the moisture content of the lumber 51a by drying the lumber 51a (S3) includes the step of decreasing the moisture content of the lumber 51a by drying the lumber 51a under atmospheric conditions of a relative humidity controlled to be a “second relative humidity”, the “second relative humidity” being lower than the “first relative humidity”. This enables the entire piece of lumber 51a to assume a state of being able to absorb moisture before the primary humidity conditioning step (S5) is performed. Consequently, it is possible to increase the moisture content of the entire piece of lumber 51a and make the moisture content uniform at the primary humidity conditioning step (S5), thus reducing differences in moisture content of the lumber 51a.

Furthermore, according to the embodiment, the “second relative humidity” is within a range from 20% RH to 35% RH both inclusive. This can relatively easily decrease the moisture content of the lumber 51a to less than 9.5%.

Furthermore, according to the embodiment, the step of decreasing the moisture content of the lumber 51a by drying the lumber 51a (S3) includes the step of decreasing the moisture content of the lumber 51a to less than 9.5%. This enables the entire piece of lumber 51a to assume a state of being able to absorb moisture before the primary humidity conditioning step (S5) is performed. Consequently, it is possible to increase the moisture content of the entire piece of lumber 51a and make the moisture content uniform at the primary humidity conditioning step (S5), thus reducing differences in moisture content of the lumber 51a.

Furthermore, according to the embodiment, the step of making the moisture content of the lumber 51a uniform (S5, S7, and S9) includes the step of making the moisture content of the lumber uniform in a range from 9.5% to 10.5% both inclusive. This can reduce the shrinkage and swelling of blocks 1 in use to a relatively small degree, even if the blocks 1 are used under a high or low humidity environment.

Furthermore, according to the embodiment, the lumber 51a is made from a broad-leaved tree. This can manufacture the blocks 1 that have a greater strength and are less likely to be deformed than blocks made from a conifer.

Furthermore, according to the embodiment, the block 1 includes: the box-shaped block main body 2 that is open at the lower surface; a plurality of projections 25 protruding upward from the upper surface of the block main body 2; and the engaging section (the side walls 22 and 23 of the block main body 2, the rib 27, and the cylindrical hollow units 28) positioned inside the block main body 2, the engaging section accommodating and engaging with projections 25 of another block 1 when both blocks 1 are coupled. The block main body 2, the projections 25, and the engaging section (the side walls 22 and 23 of the block main body 2, the rib 27, and the cylindrical hollow units 28) are formed by the shaving machining (S10). This allows a user to feel the texture or smell of a tree when using the blocks 1.

Furthermore, according to the embodiment, the block main body 2 has a cuboid shape and includes the upper surface, the lower surface, the pair of long-side surfaces, and the pair of short-side surfaces, and one of the pair of long-side surfaces and the pair of short-side surfaces is the edge grain surface, and the other is the cross grain surface. This can reduce the shrinkage and swelling of each block 1 in a right and left direction to about 0.6 to 1.6 times that in a forward and backward direction, enabling the blocks 1 in use to be mutually coupled or decoupled appropriately.

Furthermore, according to the embodiment, the block main body 2 takes the shape of a cuboid box and includes the upper wall 21 having a rectangular shape, the plurality of side walls 22 and 23, each of which has a rectangular shape and has the upper edge continuing to the outer edge of the upper wall 21, and the lower-surface opening (the opening 24) surrounded by the lower edges of the side walls 22 and 23. The engaging section includes the side walls 22 and 23, the rib 27 that is positioned at the center of the opening 24 and divides the opening 24 into two opening portions 24a and 24b, and the cylindrical hollow projections (cylinder hollow units 28) or the cylindrical solid projections (cylindrical solid units), positioned inside the respective opening portions 24a and 24b and protruding downward from an inner surface of the upper wall 21. This enables blocks 1 to be mutually coupled or decoupled appropriately.

Furthermore, according to the embodiment, the step of subjecting the lumber to the shaving machining (S10) includes the step of shaving the projections 25 and then shaving the engaging section (the side walls 22 and 23 of the block main body 2, the rib 27, and the cylindrical hollow units 28). This can prevent the lumber 51a from being deformed and curved, unlike the above, during a process of forming blocks 1 by subjecting the lumber 51a to the shaving machining.

Furthermore, according to the embodiment, a method for manufacturing the blocks 1 includes the steps of: increasing a moisture content of the lumber 51a that has been dried and making the moisture content uniform by leaving the lumber 51a under atmospheric conditions of a relative humidity controlled to be the “first relative humidity” (S5, S7, and S9); and forming the block 1 by subjecting the lumber 51a with the uniform moisture content to shaving machining under the atmospheric conditions of a relative humidity controlled to be the “first relative humidity” (S10). Specifically, the lumber 51a is dried so that its moisture content decreases, and then the moisture content is increased and made uniform. In this way, the entire piece of lumber 51a assumes a state of being able to absorb moisture, and then the moisture content of the entire piece of lumber 51a is increased and made uniform. Thus, differences in moisture content of the lumber 51a thereby can be decreased. Consequently, it is possible to reduce unequal shrinkage and swelling among the blocks 1, allowing the blocks 1 to be mutually coupled or decoupled appropriately.

Furthermore, according to the embodiment, a method for manufacturing the blocks 1 includes the steps of: decreasing a moisture content of the lumber 51a by drying the lumber 51a under atmospheric conditions of a relative humidity controlled to be the “second relative humidity” (S3); increasing the moisture content of the lumber 51a that has been dried and making the moisture content uniform by leaving the lumber 51a under atmospheric conditions of a relative humidity controlled to be the “first relative humidity”, the “first relative humidity” being higher than the “second relative humidity” (S5, S7, and S9); and forming the block 1 by subjecting the lumber 51a with the uniform moisture content to shaving machining under the atmospheric conditions of a relative humidity controlled to be the “first relative humidity” (S10). Specifically, the lumber 51a is dried so that its moisture content decreases, and then the moisture content is increased and made uniform. In this way, the entire piece of lumber 51a assumes a state of being able to absorb moisture, and then the moisture content of the entire piece of lumber 51a is increased and made uniform. Thus, differences in moisture content of the lumber 51a can be decreased. Consequently, it is possible to reduce unequal shrinkage and swelling among blocks 1, allowing the blocks 1 to be mutually coupled or decoupled appropriately.

The embodiment illustrated in the drawings is an example of the present invention. Obviously, the present invention includes, in addition to aspects indicated directly by the foregoing embodiment, various modifications and variations that one skilled in the art could conceive of without departing from the scopes of the claims.

### REFERENCE SYMBOL LIST

1, 1a, 1b Wooden building block
2 Block main body
21 Upper wall
22, 23 Side wall
24 Opening
24a, 24b Opening portion
25 Projection
26, 26a, 26b Internal space
27 Rib
28 Cylindrical hollow unit
50 Log
51 Square lumber
51a Lumber
52 End grain surface
53 Edge grain surface
54 Cross grain surface
70 Cutting apparatus
71 Floor surface
72 Base
73 Table
74 Head
75 Cutting tool
76 Control panel

1. A method for manufacturing wooden building blocks, comprising the steps of:
increasing a moisture content of lumber that has been dried and making the moisture content uniform; and
forming a wooden building block by subjecting the lumber with the uniform moisture content to shaving machining.

2. The method for manufacturing wooden building blocks, according to claim 1, wherein the step of increasing the moisture content of the lumber and making the moisture content uniform comprises the step of increasing the moisture content of the lumber and making the moisture content uniform by leaving the lumber under atmospheric conditions of a relative humidity controlled to be a first relative humidity.

3. The method for manufacturing wooden building blocks, according to claim 2, wherein the step of forming the wooden building block comprises the step of forming the wooden building block by subjecting the lumber to the shaving machining under the atmospheric conditions of a relative humidity controlled to be the first relative humidity.

4. The method for manufacturing wooden building blocks, according to claim 2, wherein the first relative humidity is set on the basis of an usage environment of the wooden building block.

5. The method for manufacturing wooden building blocks, according to claim 2, wherein the first relative humidity is within a range from 40% RH to 60% RH both inclusive.

6. The method for manufacturing wooden building blocks, according to claim 2, further comprising the step of decreasing the moisture content of the lumber by drying the lumber, before the step of increasing the moisture content of the lumber and making the moisture content uniform,
wherein the step of decreasing the moisture content of the lumber by drying the lumber comprises the step of decreasing the moisture content of the lumber by drying the lumber under atmospheric conditions of a relative humidity controlled to be a second relative humidity, the second relative humidity being lower than the first relative humidity.

7. The method for manufacturing wooden building blocks, according to claim 6, wherein the second relative humidity is within a range from 20% RH to 35% RH both inclusive.

8. The method for manufacturing wooden building blocks, according to claim 6, wherein the step of decreasing the moisture content of the lumber by drying the lumber comprises the step of decreasing the moisture content of the lumber to less than 9.5%.

9. The method for manufacturing wooden building blocks, according to claim 1, wherein the step of making the moisture content of the lumber uniform comprises the step of making the moisture content of the lumber uniform in a range from 9.5% to 10.5% both inclusive.

10. The method for manufacturing wooden building blocks, according to claim 1, wherein the lumber is made from a broad-leaved tree.

11. The method for manufacturing wooden building blocks, according to claim 1, wherein the wooden building block comprises:
a box-shaped block main body that is open at a lower surface;
a plurality of projections protruding upward from an upper surface of the block main body; and
an engaging section positioned inside the block main body, the engaging section accommodating and engaging with projections of another wooden building block when both wooden building blocks are coupled,
wherein the block main body, the projections, and the engaging section are formed by the shaving machining.

12. The method for manufacturing wooden building blocks, according to claim 11, wherein the block main body has a cuboid shape and comprises the upper surface, the lower surface, a pair of long-side surfaces, and a pair of short-side surfaces, wherein one of the pair of long-side surfaces and the pair of short-side surfaces is an edge grain surface, and the other is a cross grain surface.

13. The method for manufacturing wooden building blocks, according to claim 11,
wherein the block main body takes the shape of a cuboid box and comprises an upper wall having a rectangular shape, a plurality of side walls, each of which has a rectangular shape and has an upper edge continuing to an outer edge of the upper wall, and a lower-surface opening surrounded by lower edges of the side walls, and
wherein the engaging section comprises the side walls, a rib that is positioned at the center of the lower-surface opening and divides the lower-surface opening into two opening portions, and cylindrical hollow projections or cylindrical solid projections, positioned inside the respective opening portions and protruding downward from an inner surface of the upper wall.

14. The method for manufacturing wooden building blocks, according to claim 11, wherein the step of subjecting the lumber to the shaving machining comprises the step of shaving the projections and then shaving the engaging section.

15. A method for manufacturing wooden building blocks, comprising the steps of:
increasing a moisture content of lumber that has been dried and making the moisture content uniform by leaving the lumber under atmospheric conditions of a relative humidity controlled to be a first relative humidity; and
forming a wooden building block by subjecting the lumber with the uniform moisture content to shaving machining under the atmospheric conditions of a relative humidity controlled to be the first relative humidity,
wherein the wooden building block comprises:
a box-shaped block main body that is open at a lower surface;
a plurality of projections protruding upward from an upper surface of the block main body; and
an engaging section positioned inside the block main body, the engaging section accommodating and engaging with projections of another wooden building block when both wooden building blocks are coupled,
wherein the block main body, the projections, and the engaging section are formed by the shaving machining.

16. A method for manufacturing wooden building blocks, comprising the steps of:
decreasing a moisture content of lumber by drying the lumber under atmospheric conditions of a relative humidity controlled to be a second relative humidity;
increasing the moisture content of the lumber that has been dried and making the moisture content uniform by leaving the lumber under atmospheric conditions of a relative humidity controlled to be a first relative humidity, the first relative humidity being higher than the second relative humidity; and
forming a wooden building block by subjecting the lumber with the uniform moisture content to shaving machining under the atmospheric conditions of a relative humidity controlled to be the first relative humidity,
wherein the wooden building block comprises:
a box-shaped block main body that is open at a lower surface;
a plurality of projections protruding upward from an upper surface of the block main body; and
an engaging section positioned inside the block main body, the engaging section accommodating and engaging with projections of another wooden building block when both wooden building blocks are coupled,
wherein the block main body, the projections, and the engaging section are formed by the shaving machining.
